(19) United States
(12) Patent Application Publication
(10) Pub. No.: US 2025/0207444 A1
(43) Pub. Date: Jun. 26, 2025

(54) HINGE STRUCTURE AND CLIP EQUIPPED WITH THE HINGE STRUCTURE

(71) Applicant: NEWFREY LLC, New Britain, CT (US)

(72) Inventor: Shin KATAOKA, Utsunomiya-shi (JP)

(21) Appl. No.: 18/989,231

(22) Filed: Dec. 20, 2024

(30) Foreign Application Priority Data
Dec. 26, 2023 (JP) 2023-219245

(51) Int. Cl. E05D 11/10; F16B 2/20

(52) U.S. Cl. CPC E05D 11/105; F16B 2/20; E05Y 2201/21

(57) ABSTRACT

A clip for securing an element to a larger assembly. The clip comprises a body, a lid, and a hinge for rotatably connecting the lid to the body. The hinge defines a hinge axis and includes a pin and a socket. The pin includes an interference part comprising a long side and a short side. The socket defines a hole having a long side and a short side and surrounds the interference part of the pin. The hole's short side being shorter than the long side of the pin, and the hole's long side defining a recess. The lid can be opened and closed relative to the body. When the lid is opened to an upright position relative to the body, the short side of the interference part of the pin fits into the recess of the hole of the socket so that the lid is held upright.

### CROSS-REFERENCE TO RELATED APPLICATIONS

This application claims priority from Japanese Patent Application No. 2023-219245, filed on Dec. 26, 2023, the entire disclosure of which is incorporated herein by reference.

### BACKGROUND OF THE PRESENT INVENTION

The present invention relates to a hinge structure and a clip equipped with the hinge structure.

Generally, when attaching and fixing a mounting member such as a busbar to a mounting member such as an automobile body, the clip is inserted into a stay provided on the automobile body and fixed in advance, and then the busbar is attached to the clip and fixed.

When attaching a busbar to a clip, it is preferable that the clip cover be held in an open state relative to the clip body so that the busbar can be easily attached without interfering with the clip cover, and a clip equipped with a hinge structure such as that shown in Patent Document 1 is provided.

However, for example, if the stay for inserting and fixing the clip is provided in a narrow, recessed part of an automobile body, when attaching a busbar to a clip fixed in such a place, the clip cover may interfere with surrounding parts, and the clip cover may not be held in an open state relative to the clip body. In such a case, if the operator does not hold the clip lid by hand, holding the clip lid in an open state relative to the body, the clip lid may close under its own weight, making it difficult to attach the busbar, and so forth. Even if the operator holds the clip lid by hand in order to hold the clip lid in an open state relative to the body, as described above, if the clip is fixed to a narrow part, it may be difficult for the operator to reach such a part.

In addition, if the clip is fixed at multiple points, it may be impossible for the operator to hold all the clip lids by hand at the same time in order to hold all the clip lids in an open state. Furthermore, when removing the busbar, etc. from the clip and reattaching it to the clip for the purpose of maintenance, and the like, it may be necessary to release the engagement between the clip lid and the body and then hold the clip lid in an open state relative to the body of the clip.

[Patent Document 1] Japanese Unexamined Patent Application Publication No. 2018-71647.

### SUMMARY OF THE INVENTION

In light of the above circumstances, the problem to be solved by the present invention is to provide a hinge structure capable of holding the lid of a clip in an open state relative to the clip body in a narrow part, and a clip equipped with the hinge structure.

The present invention has been developed to solve such problems; the hinge structure in one embodiment of the present invention is a hinge structure for rotatably connecting a body and a lid, having a pin and a socket on at least a part of the axis of the hinge, wherein the pin is equipped with an interference part comprising a long side and a short side, the socket comprises a hole part having a long side and a short side, surrounding the interference part of the pin, the short side being shorter than the long side of the pin, and the long side comprising a recess; the lid can be opened and closed relative to the body via the hinge structure, and when the lid is opened so as to stand upright relative to the body, the short side of the interference part of the pin fits into the recess of the hole part of the socket, so that the lid is held in an upright position relative to the body.

In another embodiment of the hinge structure, the interference part and the hole part may be elliptical.

In another embodiment of the hinge structure, the hinge structure is configured so that the socket further comprises a first restricting surface and a second restricting surface, when the lid is closed on the body, the first regulating surface abuts the long side surface of the interference part of the pin to regulate the movement of the lid in a first direction in which the long side surface of the interference part of the pin presses against the first regulating surface within the hole, and the second regulating surface abuts the short side surface of the interference part of the pin to regulate the movement of the lid in a second direction in which the short side surface of the interference part of the pin presses against the second regulating surface within the hole.

In another embodiment of the hinge structure, the hinge structure is configured so that the lid further comprises a third restricting surface and a fourth restricting surface, when the lid is closed on the body, the third regulating surface abuts the body to regulate movement in a third direction opposite the first direction in which the third regulating surface presses against the body, and the fourth regulating surface abuts the body to regulate movement in a fourth direction opposite the second direction in which the fourth regulating surface presses against the body, thereby regulating movement of the lid.

Furthermore, the clip of the embodiment of the present invention is a clip equipped with any of the hinge structures of the embodiments of the present invention.

According to the hinge structure of the present invention, the lid of the clip can be held in an open state relative to the clip body in a narrow part.

### BRIEF DESCRIPTION OF THE DRAWINGS

FIG. 1 is a perspective view from above of the clip with the lid opened 180 degrees.

FIG. 2 is a perspective view from below of the clip with the lid opened 180 degrees.

FIG. 3 is a left side view of the clip with the lid opened 180 degrees.

FIG. 4 is a cross-sectional view taken along line A-A in FIG. 1.

FIG. 5 is a perspective view from below of the clip with the lid opened 90 degrees.

FIG. 6 is a left side view of the clip with the lid opened 90 degrees.

FIG. 7 is a diagram showing how a busbar is attached to a clip installed in a narrow part.

FIG. 8 is a perspective view of the clip with the lid closed.

FIG. 9 is a cross-sectional view taken along line B-B in FIG. 8.

FIG. 10 is a cross-sectional view taken along line C-C in FIG. 8.

FIG. 11 is a cross-sectional view taken along line D-D in FIG. 8.

### DESCRIPTION OF THE PREFERRED EMBODIMENTS

The hinge structure of the embodiment of the present invention will now be described below with reference to the drawings.

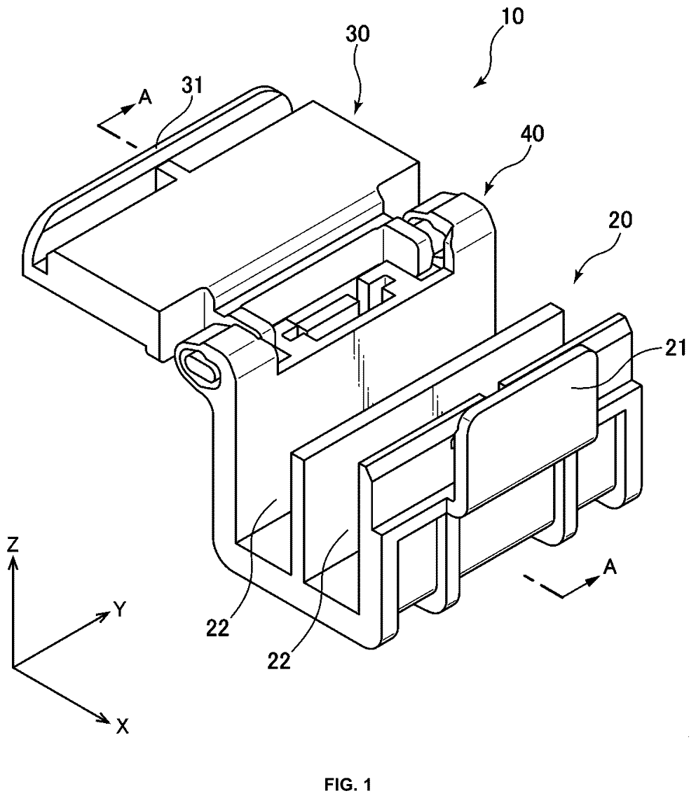

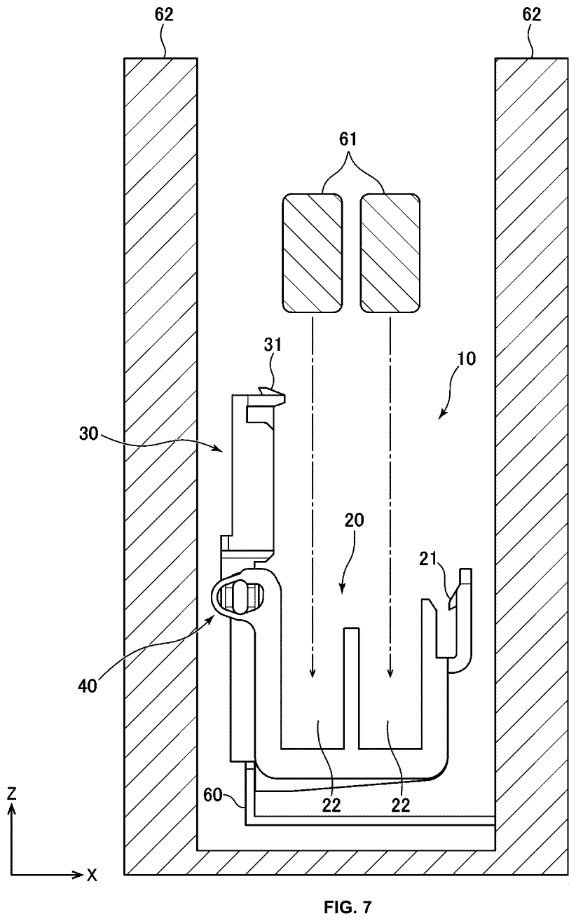

FIG. 1 shows a perspective view of a clip 10 from above with the lid 30 of the embodiment of the present invention opened 180 degrees. The clip 10 is made of resin, for example. The clip 10 includes a body 20 and a lid 30. The body 20 and the lid 30 are rotatably connected by a hinge 40. The lid 30 can be opened and closed relative to the body 20 by rotating via the hinge structure. The body 20 is configured to be able to hold a busbar 61, which will be described later in FIG. 7. In the present embodiment, the body 20 has two receiving parts 22 so that it can hold two busbars. The body 20 includes a lid locking claw receiver 21. In the present embodiment, the lid locking claw receiver 21 includes a protrusion. The lid 30 is equipped with a lid locking claw 31. In the present embodiment, the lid locking claw 31 comprises a protrusion. As described below, in the present embodiment, when the lid 30 rotates relative to the body 20 via the hinge 40 and the lid 30 is closed relative to the body 20, the protrusion of the lid locking claw 31 and the protrusion of the lid locking claw receiver 21 engage with each other, and the lid locking claw 31 and the lid locking claw receiver 21 are engaged, thereby holding the lid 30 in a closed state relative to the body 20.

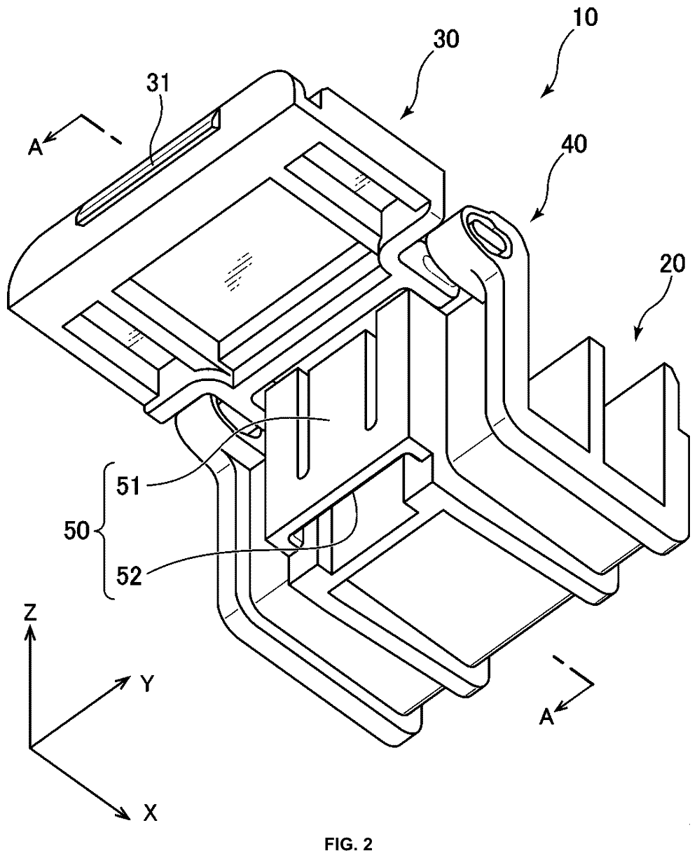

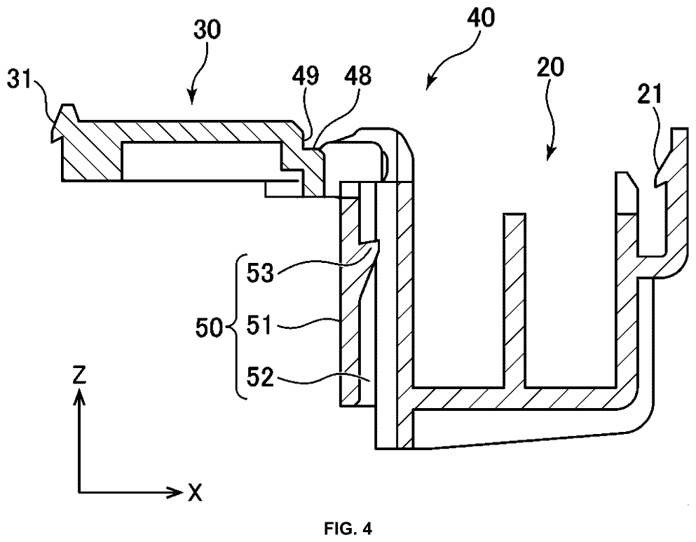

FIG. 2 shows a perspective view of the clip 10 from below with the lid 30 of the embodiment of the present invention opened 180 degrees. The clip 10 is equipped with a stay holding part 50. The stay holding part 50 is provided with a stay holding piece 51, a stay insertion hole 52 and a stay locking claw 53. As concerns the stay locking claw 53, by also referring to FIG. 4, it can be understood that the stay locking claw 53 is provided on the stay holding part 50. As will be described later, the stay 60 is inserted into the stay insertion hole 52 of the stay holding piece.

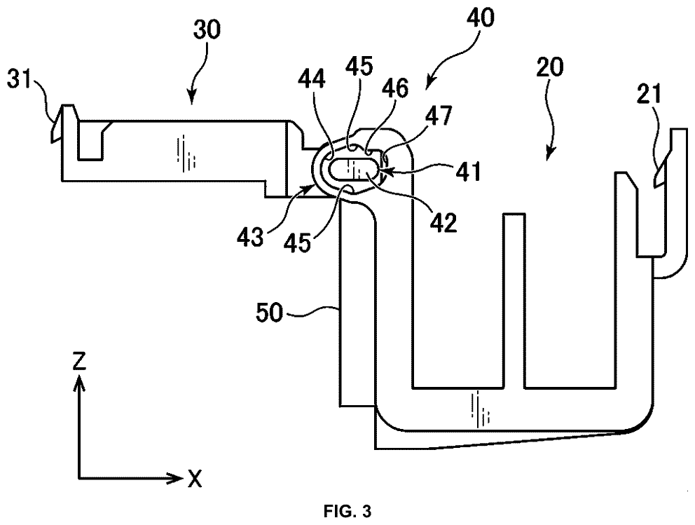

FIG. 3 shows a left side view of the clip 10 with the cover 30 opened 180 degrees according to an embodiment of the present invention. Note that in the present embodiment, the right side view of the clip 10 is omitted inasmuch as it is symmetrical to the left side view. The axis of the hinge 40 extends in the Y-axis direction, and at least a part of the axis of the hinge 40 is equipped with with a pin 41 and a socket 43. In the present embodiment, the axis of the hinge 40 is equipped with a pin 41 and a socket 43 at two locations, one end and the other end. FIG. 3 shows one end. Further, the location where the pin 41 and the socket 43 are provided is not limited hereto, and for example, the hinge 40 axis can be configured to have the pin 41 and the socket 43 at only one location at one end. The pin 41 is equipped with an interference part 42. The interference part 42 comprises a long side in the X-axis direction and a short side in the Z-axis direction in the XZ plane. In the present embodiment, the interference part 42 is elliptical in the XZ plane. The socket 43 comprises a hole 44. In the present embodiment, the hole 44 comprises a long side in the X-axis direction and a short side in the Z-axis direction in the XZ plane. The hole 44 is provided so as to surround the interference part 42 of the pin 41, and the short side of the hole 44 is set to be shorter than the long side of the interference part 42. In the present embodiment, the interference part 42 is elliptical in the XZ plane. In addition, in the present embodiment, the long side of the hole 44 comprises recesses 45 in two places. The hole 44 of the socket 43 comprises a first restriction surface 46 and a second restriction surface 47.

FIG. 4 shows a cross-sectional view taken along line A-A in FIG. 1. As described above, the stay locking claw 53 is provided on the stay holding part 50. The stay locking claw 53 is configured to hook onto the stay 60 inserted into the stay insertion hole 52 and hold the stay 60 within the stay holding piece 51. The lid 30 comprises a third restricting surface 48 and a fourth restricting surface 49.

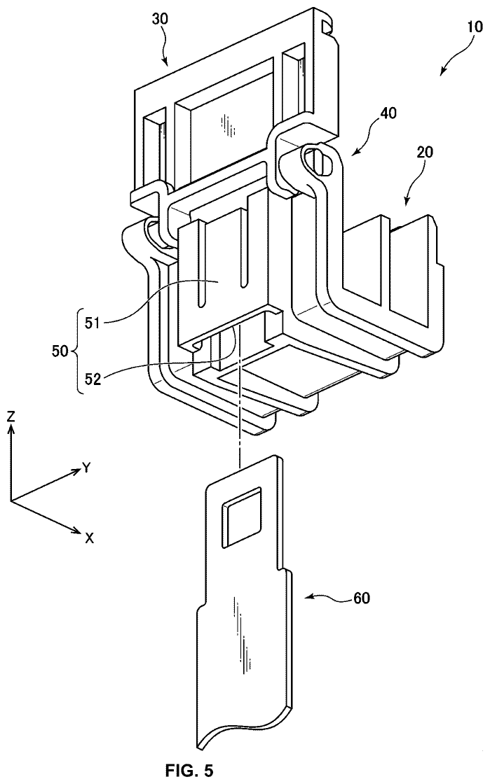

FIG. 5 shows a perspective view of the clip 10 from below with the lid 30 opened 90° according to an embodiment of the present invention. The lid 30 opened 90° is a state in which the lid 30 has been rotated 90° relative to the body 20 via the hinge 40 from the state shown in FIG. 1 in which the lid 30 is opened 180°. With the lid 30 opened 90° in this manner, the stay 60 is inserted into the stay insertion hole 52 in the Z-axis direction as shown by the dashed line.

In the present embodiment, when the stay 60 is inserted into the stay insertion hole 52, the stay locking claw 53 engages with the hole provided in the stay 60, thereby locking the stay 60. In this way, the stay 60 is locked by the stay locking claw 53, and is held within the stay holding piece 51.

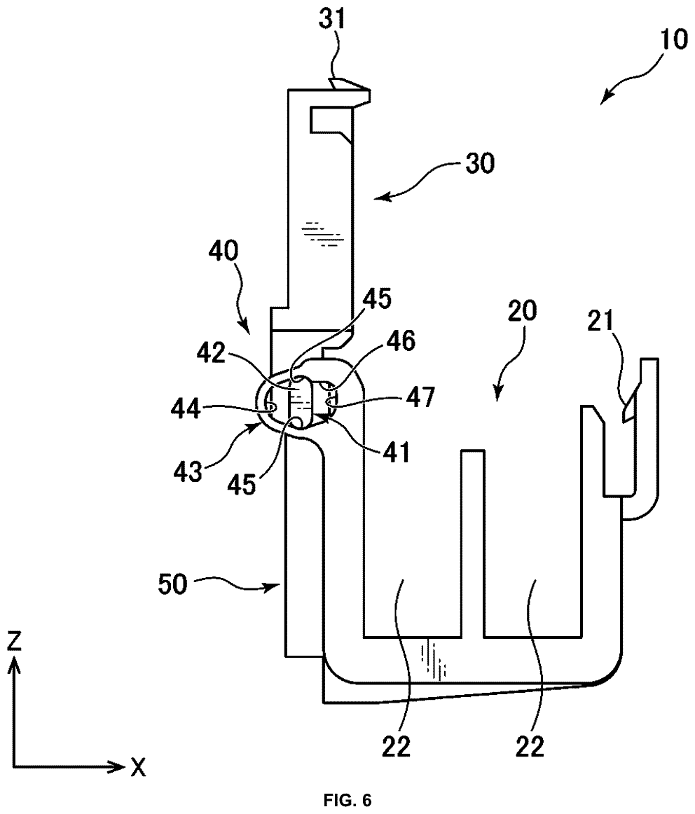

FIG. 6 shows a left side view of the clip 10 in a state in which the lid 30 is opened 90° in the present embodiment of the present invention. As in FIG. 3, the right side view of the clip 10 is omitted in the present embodiment inasmuch as it is symmetrical to the left side view. The hinge 40 will be described in detail by comparing FIG. 6, which shows the lid 30 opened 90°, with FIG. 3, which shows the lid 30 opened 180°.

As mentioned above, in the present embodiment, the hinge 40 has a pin 41 and a socket 43 at two locations, one end and the other end of the axis. FIG. 6 shows one end. The long side of the interference part 42 extends in the X-axis direction in FIG. 3 in the XZ plane, but extends in the Z-axis direction in FIG. 6 as the lid 30 rotates 90° relative to the body 20. Similarly, the short side of the interference part 42 extends in the Z-axis direction in FIG. 3 in the XZ plane, but as the lid 30 rotates 90° relative to the body 20, the interference part 42 also rotates 90° and extends in the X-axis direction in FIG. 6. At this time, the two short sides of the interference part 42 are fitted into two recesses 45 in the hole part 44 of the socket 43. This is because the short side of the hole part 44 is set to be shorter than the long side of the interference part 42, so the short side of the interference part 42 fits into the recesses 45. By fitting the short side of the interference part 42 into the recesses 45, the lid 30 is held in a 90° open state relative to the body 20 as shown in FIG. 6.

FIG. 7 shows how the busbar 61 is attached to the clip 10 in a state wherein the clip 10 is fixed to the stay 60 installed in the narrow part formed by the wall 62 in an embodiment of the present invention. As described above, the busbar 61 can be held in the receiving part 22 of the body 20 of the clip 10. In the state shown in FIG. 7, the lid 30 is held in a 90° open state relative to the body 20. In this way, since the lid 30 is held in a 90° open state relative to the body 20, for example, the lid 30 does not interfere with the wall 62 or the lid 30 does not close due to its own weight, and the busbar 61 can be smoothly attached to the receiving part 22 without interfering with the lid 30. Further, the “90° open state” of the lid 30 relative to the body 20 may be a “state wherein the lid 30 is open so as to stand upright” relative to the body 20 to the extent that it does not interfere with the wall 62 or the busbar 61 and does not have to be strictly 90°.

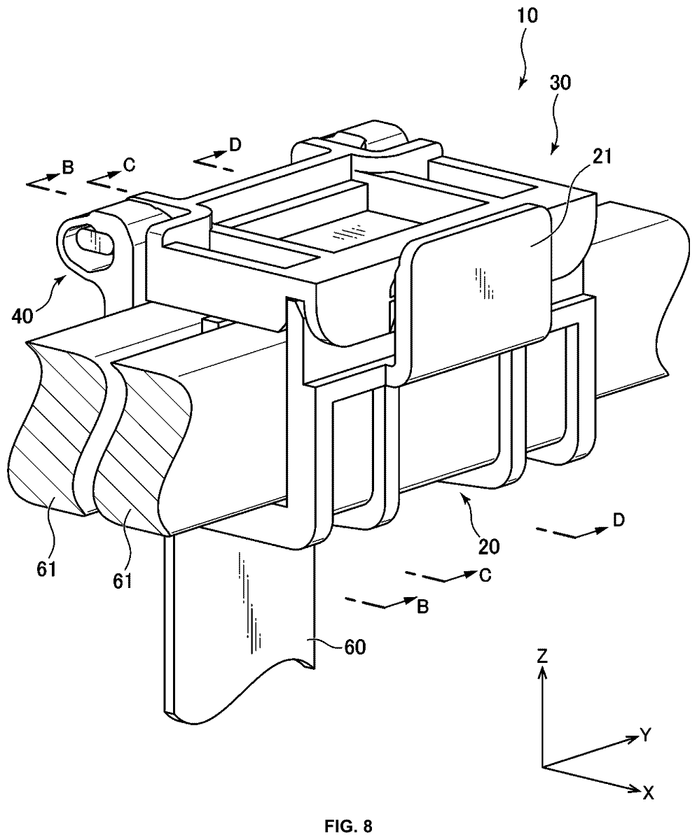

FIG. 8 shows an embodiment of the present invention in which the busbar 61 is attached to the clip 10 and the lid 30 is closed. After the busbar 61 is placed in the receiving part 22 of the body 20 of the clip 10, the lid 30 is closed to the body 20. At this time, the protrusions of the lid locking claws 31 of the lid 30 and the protrusions of the lid locking claw receiver 21 of the body 20 engage with each other, and the lid locking claws 31 and the lid locking claw receiver 21 engage with each other, thereby holding the lid 30 in a closed state relative to the body 20; thus, the clip 10 is in a state in which it holds the busbar 61.

In a clip manufactured by integrally molding the pin and socket in a combined state in one mold, a certain amount of gap is created between the pin and socket due to the structure of the mold. In a conventional clip with a gap between the body and the lid, when the busbar is placed in the receiving part of the body and the lid is closed, the busbar rattles inside the clip due to the gap. Accordingly, a clip with less rattling of the lid is required.

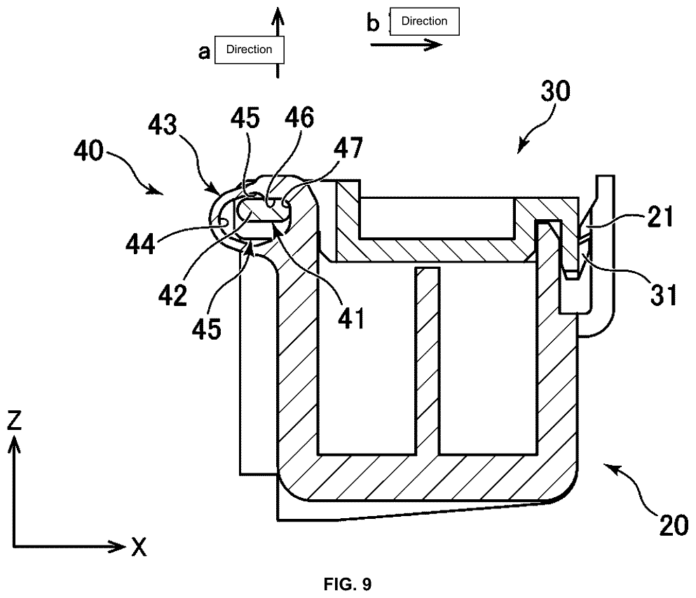

FIG. 9 shows a cross-sectional view taken along line B-B in FIG. 8. In the present embodiment, the socket 43 further is equipped with a first restricting surface 46 and a second restricting surface 47 in the hole 44. When the lid 30 is closed on the body 20, the first restricting surface 46 abuts the long side surface of the interference part 42 of the pin 41 and restricts the movement in direction a, which is the direction in which the long side surface of the interference part 42 of the pin 41 presses against the first restricting surface 46 in the hole 44. The second restricting surface 47 abuts the short side surface of the interference part 42 of the pin 41 and restricts movement in direction b, which is the direction in which the short side surface of the interference part 42 of the pin 41 presses against the second restricting surface 47 in the hole 44. In this way, by restricting the movement of the interference part 42 of the pin 41 in directions a and b, it is possible to restrict the movement of the lid 30 in directions a and b. Therefore, by providing such a configuration to the hole 44 of the socket 43, it is possible to suppress rattling of the lid 30.

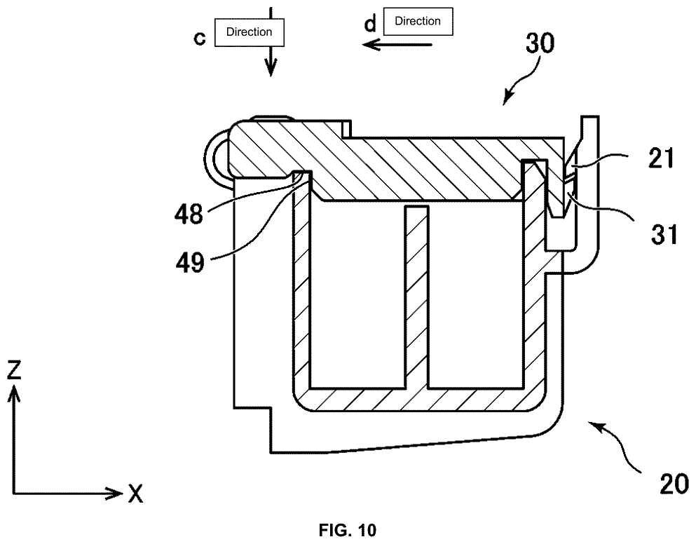

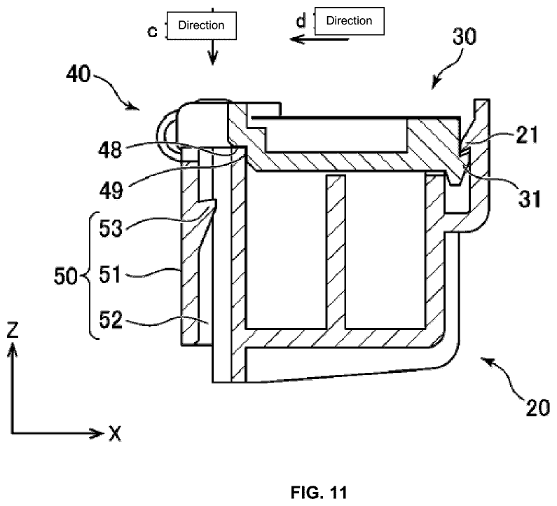

Furthermore, FIG. 10 shows a cross-sectional view taken along line C-C in FIG. 8, and FIG. 11 shows a cross-sectional view taken along line D-D in FIG. 8. In the present embodiment, the lid 30 further is further equipped with a third restricting surface 48 and a fourth restricting surface 49. Similarly, when the lid 30 is closed on the body 20, the third restricting surface 48 abuts the body 20 to restrict movement in direction c, which is the direction in which the third restricting surface 48 presses the body 20. In the present embodiment, direction c is opposite direction a. Also, the fourth restricting surface 49 abuts the body 20 to restrict movement in direction d, which is the direction in which the fourth restricting surface 49 presses the body 20. In the present embodiment, direction d is opposite direction b. In this way, by restricting the movement of the third restricting surface 48 of the lid 30 in direction c and the movement of the fourth restricting surface 49 of the lid 30 in direction d, the movement of the lid 30 in direction c and direction d can be restricted. Therefore, in addition to the configuration of the hole part 44 of the socket 43 that restricts the movement of the lid 30 in direction a and direction b as described above, by further providing such a configuration to the lid 30, rattling of the lid 30 can be further suppressed.

Although the embodiment of the present invention has been described above with reference to the drawings, the hinge structure is not limited to the specific structure described above and can be modified as appropriate, as long as it is configured to hold the lid in an open state relative to the body.

For example, in another embodiment, if one of the pins and the socket is an elastic piece, and the pin can be inserted into the socket by one being non-destructively elastically deflected, the lid and body of the clip may not be manufactured as a single piece but may be manufactured in separate molds and assembled.

Furthermore, for example, in order to increase the holding strength when the lid is held in a 90° open state relative to the body, the ratio of the length of the long side of the pin's interference part to the length of the short side may be set to a larger value so that the long side of the interference part of the pin fits deeper into the recess of the hole of the socket, the depth of the recess of the hole of the socket may be set to a deeper value and the width of the recess to be narrower, or the pin may be made of a harder material relative to the socket.

Furthermore, the hinge structure of the present invention is not limited to application to stay-inserted clips as described above using the figures, but may be appropriately applied to, for example, stud retention that firmly holds the fit, anchor leg retention that fits into a mating hole, two-part retention that fits another clip in a dog-house shape, etc.

Furthermore, the process of attaching the mounting member is not limited to the process of fixing the clip to the stay in advance as described above using the figures, then attaching the mounting member to the clip and closing the lid to fix the mounting member, but may, for example, be fixed to the mounting member by attaching the clip to the mounting member in advance and closing the lid, then fixing the clip.

It should be noted that, although the present invention has been described using exemplary embodiments, application of the present invention is not limited to application to automobiles, for example, but may be applied to various products and may be appropriately applied within the scope of the technical idea of the invention.

Reference Numbers: 10 Clip, 20 Body, 21 Lid locking claw receiver, 22 Receptacle, 30 Lid, 31 Lid retaining claw, 40 Hinge, 41 Pin, 42 Interference part, 43 Socket, 44 Hole, 45 Recess, 46 First regulating surface, 47 Second regulating surface, 48 Third regulating surface, 49 Fourth regulating surface, 50 Stay holding part, 51 Stay holding piece, 52 Stay insertion hole, 53 Stay locking claw, 60 Stay, 61 Bus bar, 62 Hole.

What is claimed is:

1. A clip for securing an element to a larger assembly, the clip comprising:
a body;
a lid;
a hinge for rotatably connecting the lid to the body, and the hinge defines a hinge axis and includes a pin and a socket on at least a part of the axis of the hinge; and;
the pin is equipped with an interference part comprising a long side and a short side,
the socket comprises a hole part having a long side and a short side and surrounds the interference part of the pin, the short side being shorter than the long side of the pin, and the long side comprising a recess; and
wherein the lid can be opened and closed relative to the body via the hinge structure, and when the lid is opened to an upright position relative to the body, the short side of the interference part of the pin fits into the recess of the hole part of the socket so that the lid is held in the upright position relative to the body.

2. The clip according to claim 1, wherein the interference part and the hole part are elliptical.

3. The clip according to claim 1, wherein the socket further comprises a first restricting surface and a second restricting surface; and when the lid is closed on the body:
the first restricting surface abuts the long side surface of the interference part of the pin to limit the movement of the lid in a first direction in which the long side surface of the interference part of the pin presses against the first restricting surface within the hole; and
the second restricting surface abuts the short side surface of the interference part of the pin to limit the movement of the lid in a second direction in which the short side surface of the interference part of the pin presses against the second restricting surface within the hole.

4. The clip according to claim 3, wherein the lid further comprises a third restricting surface and a fourth restricting surface and, when the lid is closed on the body:
the third restricting surface abuts the body to limit movement in a third direction opposite the first direction in which the third restricting surface presses against the body, and
the fourth restricting surface abuts the body to limit movement in a fourth direction opposite the second direction in which the fourth restricting surface presses against the body.

5. A clip for securing a component to a larger assembly, the clip comprising:
a body including a holding part for securing the clip to the larger assembly, and the body partially defining a receptacle operable for holding the component to the clip and partially defining an opening to the receptacle, and the body further includes one of a hinge pin or a hinge socket;
a lid movable relative to the body between a closed position over the opening and an open position at a right angle to the closed position, and the lid includes the other one of the hinge pin or the hinge socket; and
the hinge pin defines a hinge axis and includes an interference part and, in cross section perpendicular to the hinge axis, the interference part has a pin long side and a pin short side,
the hinge socket partially defines a hole that surrounds the interference part of the hinge pin and, in cross section perpendicular to the hinge axis, the hole has a hole long side and a hole short side, and the hole short side is shorter than the pin long side, and the hole long side incudes a recess; and
when the lid is in the open position, the short side of the interference part of the pin fits into the recess of the hole as in a detent so that the lid is releasably held open.

6. The clip according to claim 5, wherein the socket further defines a first restricting surface and a second restricting surface in the hole and, when the lid is in the closed position on the body, then the first restricting surface abuts the pin long side and prevents further radial movement of the pin towards the first restricting surface, and the second restricting surface abuts the pin short side and prevents further radial movement of the pin toward the second restricting surface.

7. The clip according to claim 6, wherein body further includes a first body surface and a second body surface perpendicular to the first body surface, and the lid further includes a third restricting surface and a fourth restricting surface perpendicular to the third restricting surface and, when the lid is in the closed position on the body 20, then the third restricting surface 48 abuts the first body surface to prevent further movement of the lid toward the first body surface, and the fourth restricting surface abuts the second body surface to prevent further movement of the lid toward the second body surface.

8. The clip according to claim 7, which when the lid is in the closed position:
movement of the pin towards the first restricting surface is in a first direction;
movement of the pin toward the second restricting surface is in a second direction;
movement of the lid's third restricting surface toward the first body surface is in a third direction;
movement of the lid's fourth restricting surface toward the second body surface is in a fourth direction; and
the first direction is opposite to the third direction and perpendicular to the second direction and fourth direction;
the second direction is opposite to the fourth direction and perpendicular to the first direction and the third direction; and
movement and rattling of the lid against the body is suppressed thereby.
